(19) United States
(12) Patent Application Publication
(10) Pub. No.: US 2012/0278536 A1
(43) Pub. Date: Nov. 1, 2012

(54) MEMORY DEVICE CAPABLE OF PREVENTING SPECIFIC DATA FROM BEING ERASED

(76) Inventors: Takeaki KATO, Yokohama-shi (JP); Hideo Aizawa, Yokohama-shi (JP)

(21) Appl. No.: 13/235,434

(22) Filed: Sep. 18, 2011

(30) Foreign Application Priority Data
Apr. 28, 2011 (JP) 2011-102118

(51) Int. Cl. G06F 12/00

(52) U.S. Cl. 711/103; 711/E12.008

(57) ABSTRACT

According to one embodiment, a memory device includes a nonvolatile semiconductor memory, and control section. The nonvolatile semiconductor memory includes a first memory area, and second memory area other than the first memory area. The control section receives a first command from a host, and permits use of the second memory area on the basis of the first command. The control section receives a second command from the host, and transmits a parameter indicating the capacity of the first memory area to the host on the basis of the second command. The control section further receives a third command from the host, and accesses the first memory area on the basis of the third command. When use of the second memory area is permitted, the control section receives the third command from the host, and accesses the second memory area on the basis of the third command.

### CROSS-REFERENCE TO RELATED APPLICATIONS

This application is based upon and claims the benefit of priority from prior Japanese Patent Application No. 2011-102118, filed Apr. 28, 2011, the entire contents of which are incorporated herein by reference.

### FIELD

Embodiments described herein relate generally to a memory device including a nonvolatile memory such as a NAND flash memory.

### BACKGROUND

A memory card such as an SD™ card includes a user area from which a user can freely read data or to which the user can freely write data. The total capacity of the user area is recorded in a card-specific data (CSD) register.

When processing of formatting or the like of a file system is executed by using a host apparatus such as a USB reader-writer, there is the possibility of data of the user area in the SD card being totally erased. Accordingly, for example, specific data such as a program or set data of an application set to the SD card by, for example, a card manufacturer is also erased. Accordingly, a memory device capable of preventing specific data from being erased by formatting or the like of a file system is desired.

### BRIEF DESCRIPTION OF THE DRAWINGS

FIG. 1 is a block diagram schematically showing an example of a memory card according to an embodiment.

FIG. 2 is a view schematically showing areas in a NAND flash memory shown in FIG. 1.

FIG. 3 is a view schematically showing areas in the NAND flash memory shown in FIG. 2.

FIG. 4 is a view showing an example of an argument of a command to be applied to the embodiment.

FIG. 5 is a view showing an example of an operation sequence of a command to be applied to the embodiment.

FIG. 6 is a sequence diagram showing an example of an operation of the embodiment.

FIG. 7 is a flowchart showing an example of an operation of a host of the embodiment.

FIG. 8 is a flowchart showing an example of an operation of a memory device of the embodiment.

FIG. 9 is a block diagram schematically showing another example of a memory card according to the embodiment.

### DETAILED DESCRIPTION

In general, according to one embodiment, a memory device includes a nonvolatile semiconductor memory, and control section. The nonvolatile semiconductor memory includes a first memory area, and second memory area other than the first memory area. The control section receives a first command from a host, and permits use of the second memory area on the basis of the first command. The control section receives a second command from the host, and transmits a parameter indicating the capacity of the first memory area to the host on the basis of the second command. The control section further receives a third command from the host, and accesses the first memory area on the basis of the third command. When use of the second memory area is permitted, the control section receives the third command from the host, and accesses the second memory area on the basis of the third command.

Hereinafter, embodiments will be described below with reference to the drawings.

### First Embodiment

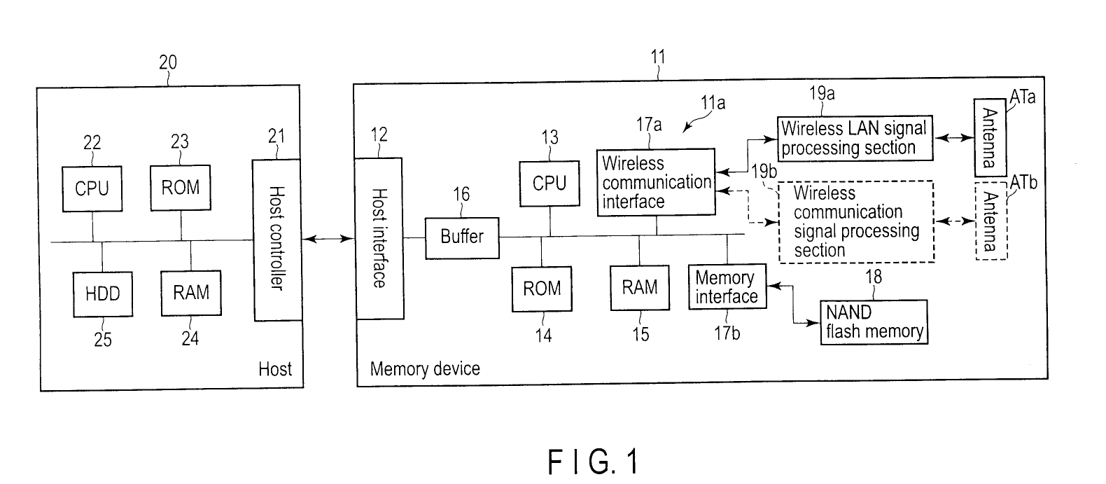

FIG. 1 shows a memory device 11 serving as, for example, an SD card to which a first embodiment is applied, and host device 20 thereof.

In FIG. 1, when the memory device 11 is connected to the host 20, the device 11 receives power supply to operate, and carries out processing corresponding to access thereto from the host 20. The memory device 11 includes a card controller 11a.

The card controller 11a is constituted of, for example, a host interface 12, CPU 13, read-only memory (ROM) 14, random access memory (RAM) 15, buffer 16, wireless communication interface 17a, and memory interface 17b. These are connected to each other by a bus. For example, a NAND flash memory 18 is connected to the memory interface 17b. A wireless LAN signal processing section 19a serving as an extended function section is connected to the wireless communication interface 17a. An antenna ATa configured to transmit/receive a high-frequency signal is connected to the wireless LAN signal processing section 19a.

It should be noted that the extended function section is not limited to the wireless LAN signal processing section 19a, and it is possible to add the other wireless communication signal processing section 19b, and antenna ATb connected to the wireless communication signal processing section 19b, thereby constituting a multifunction SD memory card. The wireless LAN signal processing section 19a controls a wireless communication function based on, for example, Wi-Fi (registered trademark), and wireless communication signal processing section 19b controls a proximity wireless communication function based on, for example, TransferJet (registered trademark).

The host interface 12 carries out interface processing between the card controller 11a and host 20.

The wireless communication interface 17a carries out interface processing between the card controller 11a and wireless LAN signal processing section 19a or wireless communication signal processing section 19b.

The memory interface 17b carries out interface processing between the card controller 11a and NAND flash memory 18.

The CPU 13 manages overall control of the memory device 11. As a program configured to control the CPU 13, firmware (a control program and the like) stored in the ROM 14 is used or is loaded into the RAM 15 to execute predetermined processing. That is, the CPU 13 creates various tables in the RAM 15, receives a write command, read command or erase command from the host 20 to access an area in the NAND flash memory 18 or to control data transfer processing through the buffer 16.

The ROM 14 stores therein firmware such as a control program and the like to be used by the CPU 13. The RAM 15 is used as a work area of the CPU 13, and stores therein a control program, various tables, and extension register to be described later.

The buffer 16 temporarily stores therein data of a given amount (for example, data of one page) when data sent from the host 20 is to be written to, for example, the NAND flash memory 18 and, temporarily stores therein data of a given amount when data read from the NAND flash memory 18 is to be sent to the host 20.

The NAND flash memory 18 is constituted of, for example, memory cells of a stacked gate structure or memory cells of a MONOS structure.

On the other hand, as the host 20, for example, a digital camera, cellular phone, personal computer, and the like can be adopted. The host 20 is constituted of a host controller 21, CPU 22, ROM 23, RAM 24 and, for example, hard disk 25 (including an SSD). These are connected to each other by a bus.

The CPU 22 controls the overall host. The ROM 23 stores therein firmware necessary for the operation of the CPU 22. Although the RAM 24 is used as, for example, a work area of the CPU 22, a program which can be executed by the CPU 22 is also loaded here to be executed. The hard disk 25 holds various data items. In the state where the memory device 11 is connected to the host controller 21, the host controller 21 carries out interface processing between itself and the memory device 11. Furthermore, the host controller 21 issues various commands to be described later in accordance with instructions from the CPU 22.

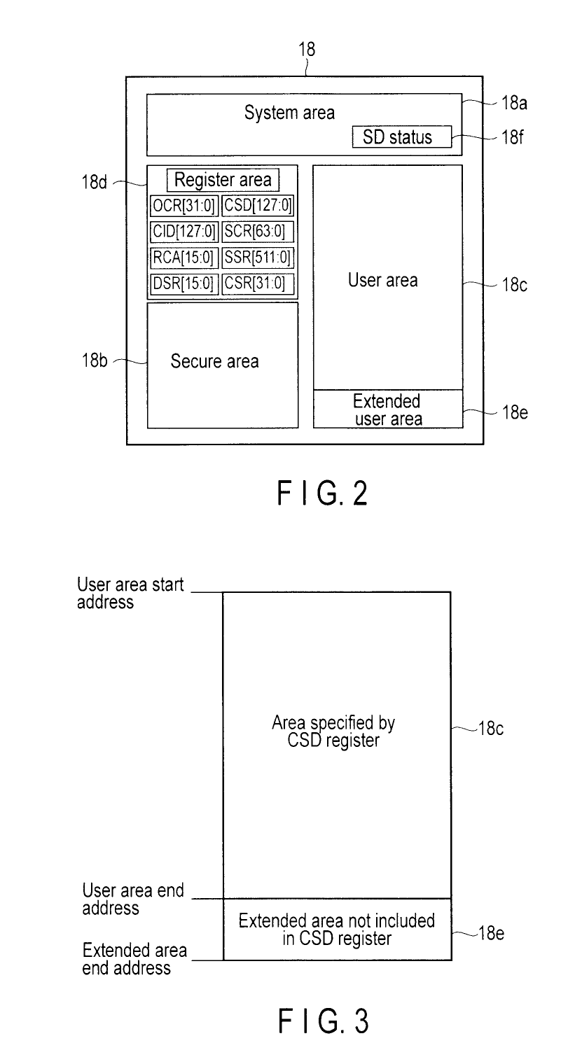

FIG. 2 schematically shows areas in the NAND flash memory 18. The memory area of the NAND flash memory 18 constituting the SD memory card generally includes a system area 18a, secure area 18b, user area 18c, and register area 18d including a plurality of registers.

The system area 18a stores therein control software configured to operate the memory device 11, and other system data, and is an area which the host 20 cannot directly access as a general user.

The secure area 18b stores therein data to be protected in terms of security, and in order that the host 20 may access the memory device 11 as a general user, it is necessary for the host 20 to carry out authentication.

The user area 18c is an area which can be freely accessed by using the host 20 as a general user.

The register area 18d includes a plurality of registers holding data such as the specification, operation conditions, and the like of the card. In a CSD register among these registers, a parameter indicating, for example, the capacity of the user area 18c is recorded. The parameter may be one parameter directly expressing the capacity or may be a plurality of parameters enabling calculation of the capacity by combining them. It should be noted that the capacity of the secure area 18b is recorded not in the CSD register, but in, for example, the system area 18a as status information called the SD status 18f.

In the case where a general user accesses the memory device 11 by using the host 20, when the memory device 11 is unformatted or when the format of the memory device 11 does not support the host 20, it is necessary, in order to make the format of the memory device 11 support the function of the host 20, to format the NAND flash memory 18 by using dedicated formatting software (also called a formatter).

Further, even in the case of an already formatted NAND flash memory 18, for example, when data in the user area 18c is once reset, it is necessary to reformat the NAND flash memory 18.

In the case of a conventional memory device, when the NAND flash memory is to be formatted, there is the possibility of data in the user area 18c, and secure area 18b being erased. Accordingly, when necessary data is recorded in the user area, it is necessary to back up the data to another memory medium. However, when the data is data such as setting data of an application function of, for example, a wireless LAN signal processing registered by, for example, a card manufacturer, the data is not managed by a file system, and hence it is even not possible to back up the data.

Thus, in the first embodiment, among commands which can be issued by a general host, for example, a command 56 (hereinafter referred to as CMD 56) that is an option for which a use is not determined is defined as an extension area switching command, and the command CMD 56 is issued from the host 20 to the memory device 11, whereby it is made possible to set permission or inhibition of access to an extended user area 18e provided in advance in the user area 18c of the card. Data recorded in the extended user area 18e is not erased even when formatting is executed, and the data can be held.

The extended user area 18e in the NAND flash memory 18 is prepared in the following manner. The NAND flash memory 18 has a physical address which is a true address. On the other hand, the card controller 11a of the memory device 11 has a logical address as an address treated by the card controller 11a. The logical address is an address used between the host 20 and card controller 11a, and has a one-to-one correspondence with the physical address. In order to operate the memory device 11, it is necessary to associate the logical address and physical address with each other. Normally, in the user area 18c, physical addresses and logical addresses are associated with each other, and a table or the like indicating the relationships is prepared. Regarding the extended user area 18e too, physical addresses and logical addresses are associated with each other as in the user area 18c.

FIG. 3 schematically shows a relationship between the user area 18c and extended user area 18e. The user area 18c is arranged from a lower start address to a higher end address, the capacity of the memory area indicated by addresses between the start address and end address is the capacity of the user area 18c. The capacity of the user area 18c is indicated by a parameter recorded in the CSD register. When the memory device 11 is to be formatted, by determining the capacity of the user area 18c from the parameter in the CSD register, the formatter recognizes that a memory area corresponding to the capacity beginning from the start address is the user area 18c.

It is possible to distinguish a logical address assigned to the extended user area 18e from the user area 18c by assigning addresses from an address subsequent to the end address of the user area 18c determined by, for example, the CSD register. The logical address assigned to the extended user area 18e is not limited to the address subsequent to the end address of the user area 18c, and it is also possible to make the logical address the other address.

By assigning the logical address to the extended user area 18e in the manner described above, it becomes possible, when a command to switch the extended area is issued from the host 20 to the memory device 11, to set permission or inhibition of access to the extended user area 18e.

It is possible not only to statically assign an address to the extended user area 18e in advance as described above, but also to dynamically assign an address thereto at, for example, a point at which the extended user area becomes necessary. In this case, for example, when a permission request of the extended user area is received from the host 20, it is possible to realize assignment of an address to the extended user area. In this case, the extended user area is not prepared from the beginning, and hence an address can be assigned to the extended user area, for example, within the range in which physical addresses and logical addresses can be associated with each other.

When the user requests permission or inhibition of access to the extended user area 18e of the NAND flash memory, the user defines the permission or inhibition as a switching command of the extended user area 18e by using the host 20, and issues a command CMD 56 in which a function is implemented to the memory device 11. The command CMD 56 has an argument of 32 bits, and among the 32 bits, only a value of a bit 0 is specified. The value of bit 0 indicates a transfer direction of data and, when bit 0 is “0”, it means a data write mode and, when bit 0 is “1”, it means a data read mode.

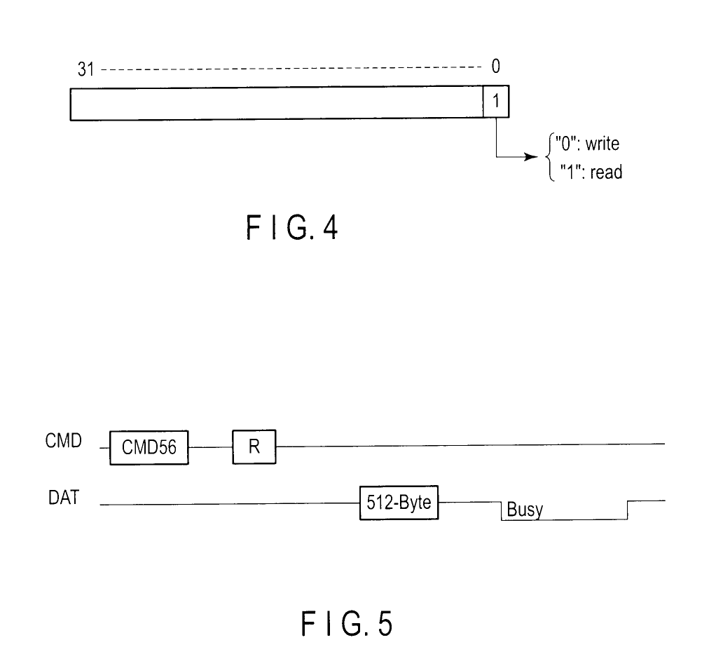

FIG. 4 shows the argument of the command CMD 56. In the command CMD 56, matters other than the above are not determined and, it is made possible for the card vendor to individually set bits 31 to 1, input/output data, and processing contents.

FIG. 5 shows an example of a command sequence of this embodiment. When the command CMD 56 is issued from the host 20, the memory device 11 receives the command CMD 56, and sends a response (R) to the host 20.

When the command CMD 56 is associated with the write mode, upon receipt of a response, the host 20 sends, for example, 512-byte data to the memory device 11. Upon receipt of the data, the memory device 11 sends a busy signal to the host 20, and executes processing in accordance with the command CMD 56.

Further, when the command CMD 56 is associated with the read mode, upon receipt of a response from the memory device 11, the host 20 receives, as will be described later, for example, a processing result of the write processing in the memory device 11 as read data.

In this embodiment, data output from the host 20 or the memory device 11 concomitantly with the issuance of the command CMD 56 from the host 20 has the following meaning when the command CMD 56 is associated with the write mode or the read mode.

For example, in the case where the command CMD 56 is associated with the write mode, when the first byte of the data output from the host 20 is “0x10” (“0x” indicates hexadecimal), the data means an access “permission request” of the extended user area 18e and, when the first byte thereof is “0x20”, the data means an access “inhibition request” of the extended user area 18e.

Further, in the case where the command CMD 56 is associated with the read mode, when the first byte of the data output from the memory device 11 is “0x10”, the data means access-liberalization “success” of the extended user area 18e and, when the first byte thereof is “0xF0”, the data means access-liberalization “failure” of the extended user area 18e.

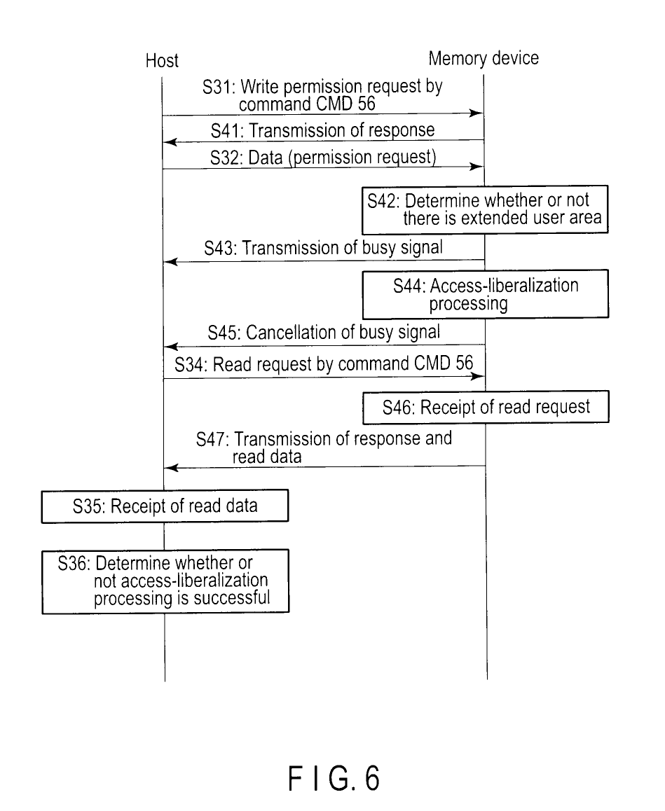

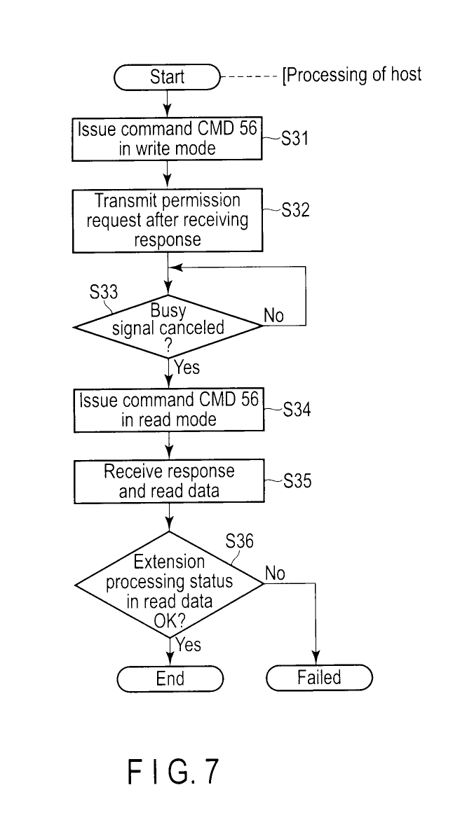

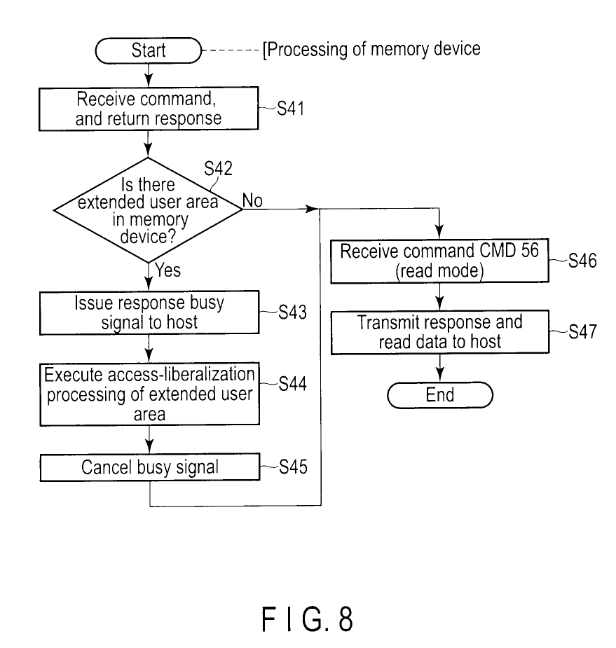

Next, an operation of issuing an access permission request of an extended user area 18e to the memory device 11 in which the extended user area 18e is defined to be carried out by the host 20 by the aforementioned static method, and operation of processing the request to be carried out by the memory device 11 will be described below with reference to FIG. 6, FIG. 7, and FIG. 8. In FIGS. 6 to 8, identical parts are denoted by identical reference symbols.

The host 20 first issues a command CMD 56 in the write mode (bit 0 is “0”) (S31). The memory device 11 receives the command CMD 56 issued from the host 20, and returns a response to the host 20 (S41).

After receiving the response, the host 20 transmits an access permission request of the extended user area 18e to the memory device 11 (S32). That is, the first byte of the write data sent to the memory device 11 is the permission request “0x10”.

The memory device 11 determines whether or not the NAND flash memory 18 includes an extended user area 18e (S42). As a result of the determination, when the NAND flash memory 18 includes the extended user area 18e, the memory device 11 tries to liberalize access to the extended user area 18e. At this time, the memory device 11 first issues a busy signal to the host 20 (S43). After this, access-liberalization processing of the extended user area 18e is executed (S44). When the access-liberalization processing of the extended user area 18e is completed, the memory device 11 cancels the busy signal (S45).

Subsequently, after confirming cancellation of the busy signal carried out by the memory device 11 (S33), the host 20 issues the command CMD 56 in the read mode (bit 0 is “1”) (S34). Upon receipt of the command CMD 56 in the read mode (S46), the memory device 11 issues, together with a response to the command, a success/failure result indicating whether the access-liberalization processing of the extended user area 18e has been successful or unsuccessful to the host 20 as the read data (S47). That is, when the first byte of the read data is “0x10”, the data means success and, when the first byte thereof is “0xF0”, the data means failure.

On the basis of the read data supplied from the memory device 11, the host 20 determines whether or not the access-liberalization processing of the extended user area 18e has been successful (S36). As a result of the determination, when the status is “0x10”, the access-liberalization processing of the extended user area 18e is successful, and it becomes possible for the host 20 to access the extended user area 18e. Further, when the status is “0xF0”, the access-liberalization processing of the extended user area 18e is unsuccessful, and the host 20 cannot access the extended user area 18e.

It should be noted that it is also possible to carry out the following in addition to the above flow.

It is possible to describe information about the capacity of the extended user area 18e for which the memory device 11 has succeeded in the access-liberalization processing in the read data of the command CMD 56. In this case, the host 20 can determine the capacity of the extended user area 18e of the memory device 11 by reading the capacity value.

Further, when the capacity of the extended user area 18e which the host wishes to use is to be described in the write data of the command CMD 56, it becomes possible for the memory device 11 to extend only an area corresponding to the capacity required by the host 20.

In either case, the host can determine the capacity of the extended user area 18e, and hence it is also possible to prevent erroneous access or the like to a range outside the extended user area 18e from being made. Furthermore, in the latter case, only an area of the necessary capacity can be made accessible, and hence it is possible to use the capacity of the extended user area 18e without wasting the capacity.

As described above, it is possible to write or read data to the memory device 11 in which the extended user area 18e has been made accessible by using a command of an ordinary SD memory card.

When necessary access to the extended user area 18e is completed, there is the possibility of the necessity for inhibiting access to the area being present. In this case, like the permission sequence shown in each of FIGS. 6 to 8, a command CMD 56 is issued to the extended user area 18e in the write mode, and the first byte of the data is made “0x20” (inhibition request). After this, the command CMD 56 is put into the read mode, and it is confirmed whether or not the inhibition processing has been successful on the basis of the read data.

When the series of processing of the command CMD 56 has been successful, the extended user area 18e is made inaccessible.

On the other hand, in the memory device 11 in the state where access to the extended user area 18e is permitted, the possibility of the power supply being turned off for some reason before access to the extended user area 18e is inhibited is conceivable. In this case, it is necessary to determine as the specification when the memory device 11 is activated next time in accordance with the use of the memory device 11 whether access to the extended user area 18e is to be permitted or to be inhibited.

More specifically, at power shutdown of the memory device 11, the right of access to the extended user area 18e, i.e., access permission information is stored in, for example, the system area 18a by the memory controller 11a. As an example, it is desirable that access to the extended user area 18e be in the inhibited state at startup.

Assuming the case where the power supply of the memory device 11 is turned off in the state where the extended user area 18e is in the access-permitted state, and the access-permitted state is maintained after turn-on of the power supply, it is necessary for the host 20 to confirm the accessible capacity of the extended user area 18e of the memory device 11.

In this case, the host 20 puts, for example, the command CMD 56 into the write mode, and sets the first byte of the data to, for example, “0x30”. This data defines a confirmation request of the capacity of the extended user area 18e of the memory device 11. After processing the write command and write data, the host 20 issues a command CMD 56 in the read mode, and receives data about the capacity of the extended user area 18e as the read data as a result of the processing of the confirmation request. By the configuration described above, it becomes possible for the host 20 to confirm the accessible capacity of the extended user area 18e.

At startup of the memory device 11, notifying the host 20 of the accessible capacity of the extended user area 18e by the memory device 11 may be in the inhibited state irrespectively of the fact that access to the extended user area 18e is in the permitted state. In this case, when the host 20 has issued a confirmation request of the capacity of the extended user area 18e to the memory device 11 by the command CMD 56, if the memory device 11 responds that the capacity of the extended user area 18e is 0 byte, the host 20 can confirm that access to the extended user area 18e is in the inhibited state.

According to the first embodiment described above, the extended user area 18e is provided in the NAND flash memory 18 of the memory device 11, and the right of access to the extended user area 18e is made switchable by using the command CMD 56 serving as an option command and write data. Accordingly, even when such access as to erase the user area 18c such as formatting or the like is made by storing, for example, an application program configured to control the wireless LAN signal processing section 19a as an application of the memory device 11, and setting data in the extended user area 18e, it is possible to protect data in the extended user area 18e.

Further, it is also possible for the host 20 to make the capacity of the extended user area 18e variable by using the command CMD 56 and write data. Thus, it is possible for the host 20 to set an extended user area 18e of the necessary size, and hence it is possible to use the extended user area 18e without wasting the capacity.

Furthermore, by dynamically carrying out assignment to the extended user area 18e, it is also possible to avoid useless assignment. Accordingly, it becomes possible to prevent the capacity of the user area 18c of the NAND flash memory 18 from being reduced, and use the user area 18c more effectively.

Further, assignment of the logical address range to the extended user area 18e is not necessarily made at an address subsequent to the user area 18c. Conversely, the extended user area 18e may also be assigned to an address separate from the user area 18c. When the extended user area 18e is assigned to an address separate from the user area 18c, an address area which cannot be assigned to a physical address of the NAND flash memory 18 is created between the user area 18c and extended user area 18e. When an address received from the host 20 together with a command designates an address area between the user area 18c and extended user area 18e, the memory device 11 transmits a response indicating that the received address corresponds to an out-of-range address area to the host 20. As described above, by interposing an out-of-range area between the extended user area 18e and user area 18c, it is possible to prevent the user from misidentifying an address, and prevent an erroneous operation of continuously writing data to the user area 18c and extended user area 18e from being carried out.

Furthermore, in the above embodiment, the extended user area 18e has been set to the user area 18c. However, setting of an area is not limited to this, and it is also possible to set an extended secure area to, for example, the secure area 18b. In this case, a sequence for authentication becomes necessary prior to the access to be made in accordance with the command CMD 56. However, it is basically possible to realize the above setting in the same manner as the sequence shown in the first embodiment. As described above, by setting an extended secure area to the secure area 18b, it is possible to store data of a higher degree of secrecy in the extended secure area.

Further, the capacity of the user area 18c is indicated by the parameter recorded in the CSD register. Accordingly, when the memory device 11 is to be formatted, it is possible for the formatter to recognize, by determining the capacity of the user area 18c from the parameter in the CSD register, that a memory area corresponding to the capacity beginning from the start address is the user area 18c.

### Second Embodiment

In the first embodiment described above, the extended user area 18e which has been made accessible is accessed by using a read command or a write command identical to that of the user area 18c.

Conversely, in a second embodiment, in order to access an extended user area 18e, a dedicated read command or a dedicated write command different from that of the user area 18c is defined.

That is, in the second embodiment too, like the first embodiment, an extended user area 18e is provided in a NAND flash memory of a memory device 11. In the second embodiment, a reserved command for which a use is not currently defined in the SDA standard is defined as an access command of the extended user area 18e.

For example, among reserved commands, a command CMD 58 is implemented as a read command of the extended user area 18e, and a command CMD 59 is implemented as a write command of the extended user area 18e. These access commands CMD 58 and CMD 59 are used to access the access-liberalized extended user area 18e.

It should be noted that a command used to access a secure area is constituted of a command different from a command used to access the user area or the extended user area.

According to the second embodiment described above, unlike the first embodiment, the access commands of the extended user area 18e and user area 18c are different from each other. Accordingly, it becomes possible to prevent access to a wrong area from being made, and prevent data from being carelessly destroyed.

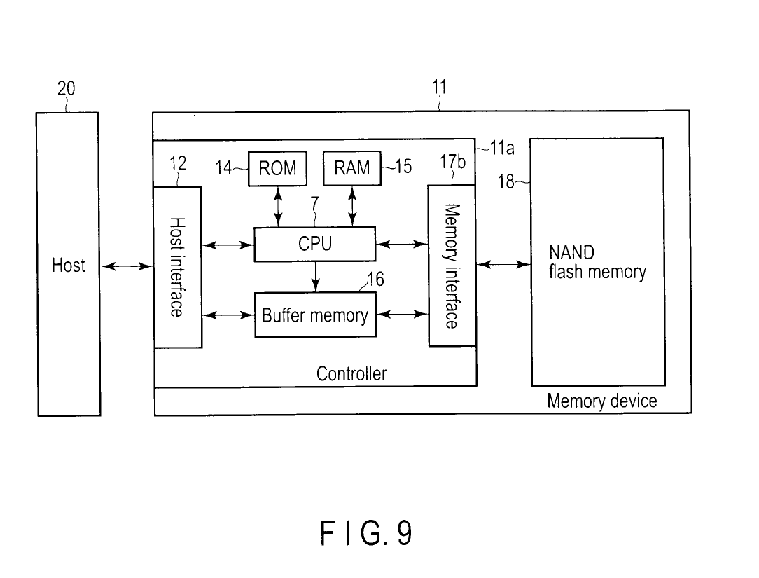

It should be noted that in the above embodiment, a memory card having a wireless communication function as an application function has been described. However, this embodiment is not limited to the above-mentioned embodiment, and can be applied to a memory device 11 having no application function as shown in, for example FIG. 9. In this case too, an extended user area 18e is provided in a NAND flash memory 18 and, for example, data which is necessary for the operation of the memory device 11, and must not be erased is stored in the extended user area 18e.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory device comprising:
a nonvolatile semiconductor memory including a first memory area, and a second memory area other than the first memory area; and
a control section configured to receive a first command from a host, and permit use of the second memory area on the basis of the first command, wherein
the control section receives a second command from the host, and transmits a parameter indicating the capacity of the first memory area to the host on the basis of the second command,
the control section receives a third command from the host, and accesses the first memory area on the basis of the third command, and
when use of the second memory area is permitted, the control section receives the third command from the host, and accesses the second memory area on the basis of the third command.

2. The device according to claim 1, wherein
an address is assigned in advance to the second memory area.

3. The device according to claim 1, wherein
an address is assigned to the second memory area when use of the second memory area is permitted by the first command.

4. The device according to claim 1, wherein
the control section stores access information configured to permit or inhibit use of the second memory area in the nonvolatile semiconductor memory at power shutdown, and brings the second memory area into a use-permitted state or a use-inhibited state on the basis of the access information stored in the nonvolatile semiconductor memory at power-on.

5. A memory device comprising:
a nonvolatile semiconductor memory including a first memory area, a second memory area other than the first memory area, and a third memory area which is made accessible after authentication to be carried out by a host; and
a control section configured to receive a first command from the host, and permit use of the second memory area on the basis of the first command, wherein
the control section receives a second command from the host, and transmits a parameter indicating the capacity of the first memory area to the host on the basis of the second command,
the control section receives a third command from the host, and accesses the first memory area on the basis of the third command, and
when use of the second memory area is permitted, the control section receives a fourth command different from the third command from the host, and accesses the second memory area on the basis of the fourth command.

6. The device according to claim 5, wherein
an address is assigned in advance to the second memory area.

7. The device according to claim 5, wherein
an address is assigned to the second memory area when use of the second memory area is permitted by the first command.

8. The device according to claim 5, wherein
the control section stores access information configured to permit or inhibit use of the second memory area in the nonvolatile semiconductor memory at power shutdown, and brings the second memory area into a use-permitted state or a use-inhibited state on the basis of the access information stored in the nonvolatile semiconductor memory at power-on.

9. The device according to claim 1, wherein
the second area is an area not to be formatted together with the first area.

10. The device according to claim 1, wherein
the second area stores therein data configured to set an application function.

11. The device according to claim 5, wherein
the second area is an area not to be formatted together with the first area.

12. The device according to claim 5, wherein
the second area stores therein data configured to set an application function.
